(19) United States
(12) Patent Application Publication
(10) Pub. No.: US 2015/0017886 A1
(43) Pub. Date: Jan. 15, 2015

(54) Method and Apparatus for Making V-Belt

(71) Applicant: Friction Coating, Inc., Sterling Heights, MI (US)

(72) Inventor: Frank Seachrist, Washington, MI (US)

(21) Appl. No.: 13/941,960

(22) Filed: Jul. 15, 2013

(51) Int. Cl. B24B 5/36; B29D 29/10; B24B 27/00

(52) U.S. Cl. CPC B24B 5/36; B24B 27/0076; B29D 29/10
USPC 451/58; 451/189; 451/28

(57) ABSTRACT

The V-belt is produced with inwardly tapered sidewalls using an apparatus having at least one motorized cutting wheel having first axis of rotation and a moving anvil system with an anvil wheel having a second axis of rotation not parallel to the first axis. The anvil system is motorized and situated so the workpiece follows a U-shaped trajectory into the path of the cutting wheel. The circumferential gripping surface of the anvil wheel and circumferential cutting surface of the cutting wheel are geometrically arranged so that at the point of contact between workpiece and cutting wheel the respective surfaces define planes that intersect in an acute angle that defines the inwardly tapered sidewalls.

### FIELD

The present disclosure relates generally to the manufacture of V-belts. More particularly, the disclosure relates to the manufacture of V-belts using an abrading or grinding apparatus.

### BACKGROUND

This section provides background information related to the present disclosure which is not necessarily prior art.

V-belts find utility in a wide range of applications where it is desired to transmit motive power between rotating shafts. For example, V-belts are widely used in automotive applications. The term “V-belt” derives from the cross-sectional shape of the belt. The V-belt is manufactured to have a pair of inwardly tapered sidewalls that are adapted to fit within the corresponding tapered structure of the pulley onto which the belt is fitted.

V-shaped drive belts have been used in machining, such as manufacturing equipment or mobile vehicles, throughout history. These belts efficiently engage both drive and driver pulleys to transmit torque to various rotatable drive members. Through time, the design of V-belts has changed from simple solid molded constructions to complicated reinforced structures. The reinforced structures, often having reinforcement cords or fibers such as Kevlar®, are typically formed on a mandrel where Kevlar® or other reinforcement fiber is wrapped about a cylinder. Polymer material such as plastic or rubber is then infused into the reinforcement phase and layered up to form a hollow tube.

Various methods are then employed to provide a finished belt having the proper size and shape. These methods include cutting a cylindrical belt from the formed tube to form a belt having a rectangular cross section with a proper width. To form the V-surfaces of the belt, several techniques have been attempted. These include simple cutting knife arrangement and grinding or abrading wheels. Such processing has proven problematic, however. It seems that during cutting or grinding, the reinforcing cord tends to get caught or snagged by the cutting surface and pulled or peeled loose from the body of the belt. When this occurs the belt must be scrapped.

Thus while the inclusion of reinforcement cords yields a stronger belt and overall improved product, the inclusion has led to an undesirable manufacturing difficulties whereby the conventional cutting or grinding process used to form the tapered side walls undesirably peels the reinforcing cord away from the body of the belt, requiring the belt to be scrapped.

### SUMMARY

This section provides a general summary of the disclosure, and is not a comprehensive disclosure of its full scope or all of its features.

We have devised a new method and apparatus that has virtually eliminated the aforementioned reinforcing cord snagging problem.

We have discovered that a particular configuration of grinding wheel and anvil wheel can produce V-belts without the aforementioned defect of pulling the reinforcing cord out from the body of the belt.

In addition, our apparatus and method produce cleanly abraded V-belts with desirable belt surface properties. The tapered sidewalls of the finished belts are uniformly smooth, with a desirable degree of native rubber or polymeric nap exposed, without any undesirable melting of the sidewall material. Surface finish can be important as uniformly smooth surfaces exposing the natural nap of the rubber or polymer tend to grip better during use. Moreover, our apparatus can do so at significantly higher speeds than were practical with conventional abrading equipment.

A more fully disclosed herein the method and apparatus produces a V-belt by cutting inwardly tapered sidewalls in a continuous belt workpiece. The apparatus includes at least one cutting wheel (two wheels being illustrated in an exemplary embodiment) having a first axis of rotation and having a circumferential cutting surface, the cutting wheel being provided with a first motive system that imparts rotation of the cutting wheel about the first axis. The apparatus further includes a moving anvil system adapted to hold the continuous belt workpiece during V-belt production. The moving anvil system includes an anvil wheel having a second axis of rotation not parallel to the first axis and having a circumferential workpiece gripping surface. The anvil system further includes a second motive system that causes the continuous belt workpiece to follow a U-shaped trajectory around the moving anvil and into the path of the cutting wheel.

The anvil wheel is positioned proximate the cutting wheel such that a portion of the continuous belt workpiece makes contact with the circumferential cutting surface and is thereby cut by the cutting wheel. The circumferential cutting surface and the circumferential gripping surface are mutually disposed such that at the point of contact between workpiece and cutting wheel, the cutting surface and the gripping surface define respective planes that intersect in an acute angle, the acute angle defining an inwardly tapered sidewall of the V-belt being produced.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a first embodiment of the V-belt grinding apparatus;

FIG. 2 is a side elevational view of a portion of a continuous belt workpiece, useful in understanding the method of manufacture;

FIG. 3 is a cross-sectional view of the belt of FIG. 2 taken substantially along the line 3-3 in FIG. 2;

FIG. 4 is a cross-sectional view of the belt of FIG. 2 after the grinding process has produced the V-shaped inclined sidewalls;

FIGS. 5a and 5b are detailed plan views showing the belt grinding operation in greater detail; FIG. 5c is an enlarged cross-sectional view of the belt, showing how cutting forces are applied;

FIGS. 6a, 6b and 6c are schematic views showing the geometries of three different embodiments of the grinding apparatus in accordance with the present disclosure;

FIG. 7 is a schematic side view showing the path of the belt across one of the grinding wheels, useful in understanding the brushing action of the disclosed embodiments;

FIG. 8 is a side view of a belt segment, showing the eccentric trajectories of exemplary cutting elements;

FIGS. 9a and 9b are detailed plan views showing a prior art belt grinding operation in greater detail; FIG. 9c is an enlarged cross-sectional view of the belt, showing how cutting forces are applied in the prior art operation of FIGS. 9a and 9b;

FIG. 10 is a schematic view showing the geometry of the prior art embodiment of FIGS. 9a, 9b and 9c;

FIG. 11 is a side view of a belt segment showing the cornrow trajectories of exemplary cutting elements from the prior art grinding operation of FIGS. 9a, 9b and 9c.

FIG. 12 is a geometric depiction of the grinding wheel and anvil comparing angle of engagement for a flat anvil versus a round anvil;

### Corresponding reference numerals indicate corresponding parts throughout the several views of the drawings.

### DETAILED DESCRIPTION

Example embodiments will now be described more fully with reference to the accompanying drawings.

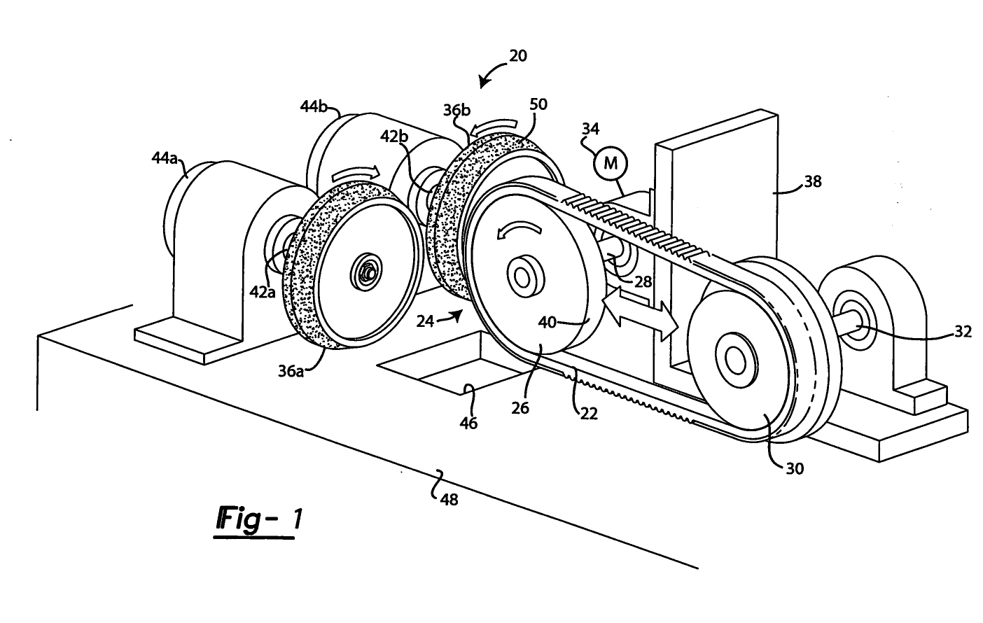

Referring to FIG. 1, a first embodiment of a grinding apparatus in accordance with the present disclosure is illustrated at 20. The workpiece belt to be processed is shown at 22, mounted on a moving anvil system 24. The moving anvil system includes an anvil wheel 26 journaled for rotation about shaft 28 and take-up wheel 30, journaled for rotation about shaft 32. Shaft 28 is driven for rotation by a motor shown diagrammatically in FIG. 1 at 34. The direction rotation is such that the belt 22 moves downwardly into the path of the grinding wheels 36a and 36b.

The take-up wheel 30 of the moving anvil system is preferably disposed on a repositionable, sliding carriage 38 that allows the take-up wheel to be moved both closer and farther from the anvil wheel. The sliding carriage 38 thus allows the belt 22 to be installed on the respective anvil and take-up wheels and then stretched to tighten, ensuring that the belt is held firmly on the anvil wheel during grinding. The anvil wheel 26 and the take-up wheel 30 may be provided with a roughened gripping surface that will grip the underside of the belt once tension is applied by stretching the belt. The sliding carriage 38 is also adjustably positioned so that the continuous belt workpiece can be positioned into cutting contact with the grinding wheels 36a and 36b.

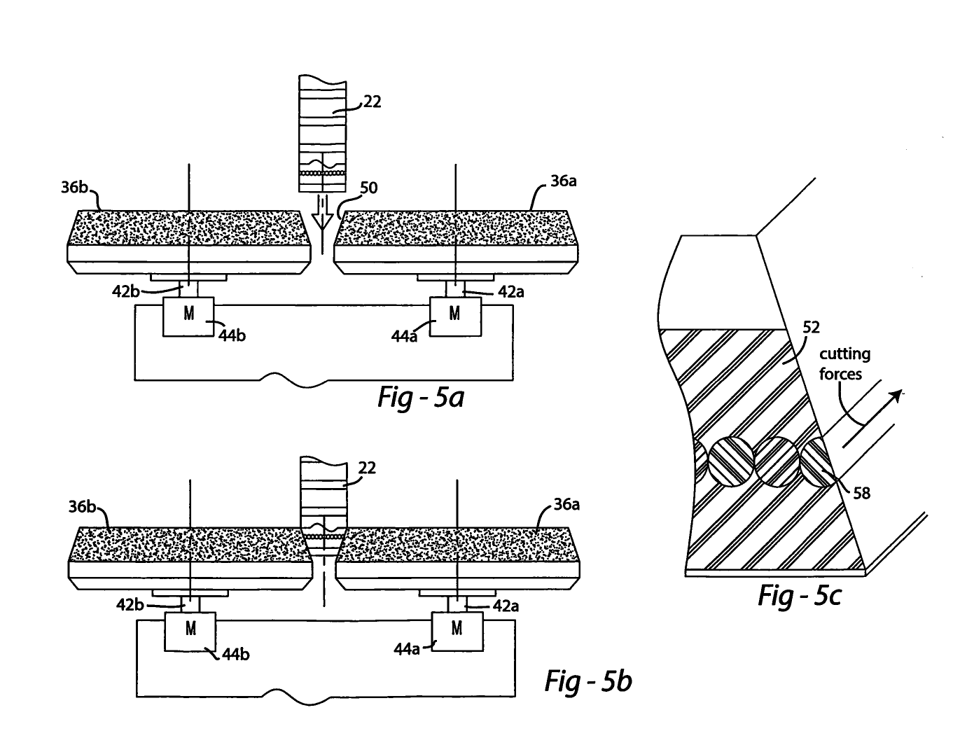

As seen in FIGS. 5a and 5b, the grinding wheels 36a and 36b are each journaled for rotation on separate parallel shafts 42a and 42b, respectively. The shafts are driven by motors 44a and 44b, respectively, with rotation of motor 44a being clockwise and motor 44b being counterclockwise (as seen in FIG. 1), so that the grinding wheels throw the waste material downwardly into an opening 46 defined in the bench 48. The grinding wheels 36a and 36b are each fabricated with a tapered circumferential surface 50 that along with the rotational axis of the shafts 42a and 42b, define the cut angle by which the belt is fabricated.

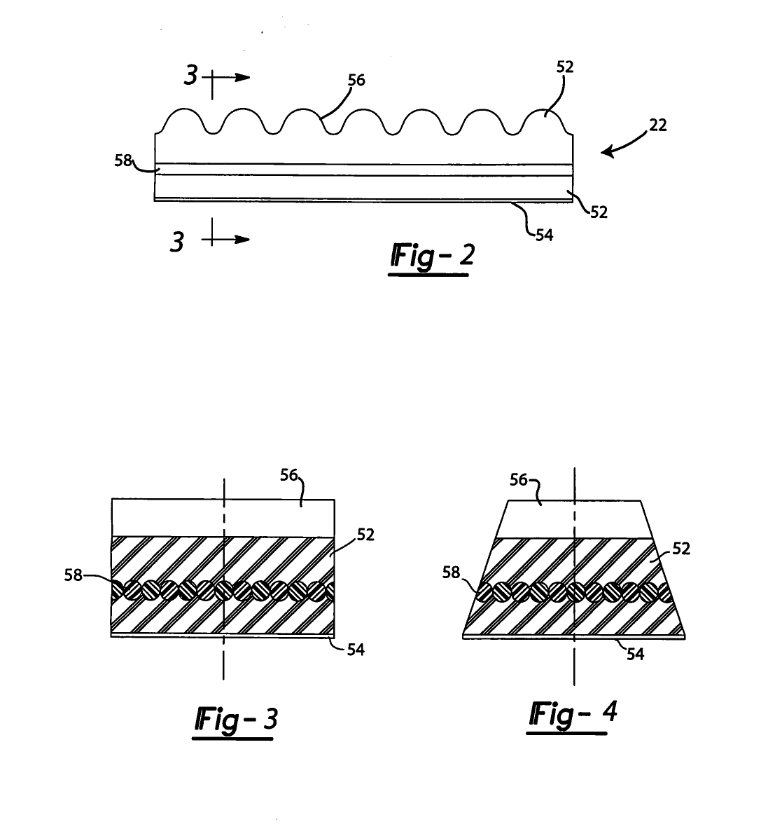

To better understand the grinding apparatus and the method of fabricating V-belts, an explanation of an exemplary V-belt will now be provided in connection with FIGS. 2, 3 and 4. Although belt configurations may differ, the belt illustrated in FIGS. 2-4 will serve to illustrate the general nature of the V-belt configuration and the difficulties encountered during manufacture by conventional means.

The V-belt 22 shown in FIGS. 2-4 comprises a substrate body 52 which may also include a backing fabric 54. The outer surface of the belt may be provided with a toothed configuration 56, if desired, based on the belt application. The toothed configuration is used where the belt during use engages with a geared mechanism.

The belt may be constructed by wrapping polymeric material around a drum to form a first layer. A second layer is formed of tensile cord by wrapping the cord in a spiral pattern the entire length of the first layer. Finally the tensile cord is encased in a third layer of polymeric material which totally encapsulates the tensile cord. The sleeve formed by this process is cured and then sliced into individual blanks having a rectangular cross section. A final grinding operation removes material to form a V-shaped cross section. In accordance with the teachings herein, the grinding apparatus of the present disclosure performs this final grinding operation.

As perhaps best seen in FIGS. 3 and 4 (but also seen in FIG. 2), the belt is provided with a series of reinforcing cords 58 of a suitably strong material such as Kevlar®. The Kevlar® reinforcing cords increase the tensile strength of the belt. FIG. 3 shows the belt before grinding and FIG. 4 shows the belt after grinding. It is these reinforcing cords, particularly the partially exposed cord adjacent the tapered sidewalls that are prone to being pulled or snagged when manufactured by conventional means.

Grinding Wheel and Anvil Geometries

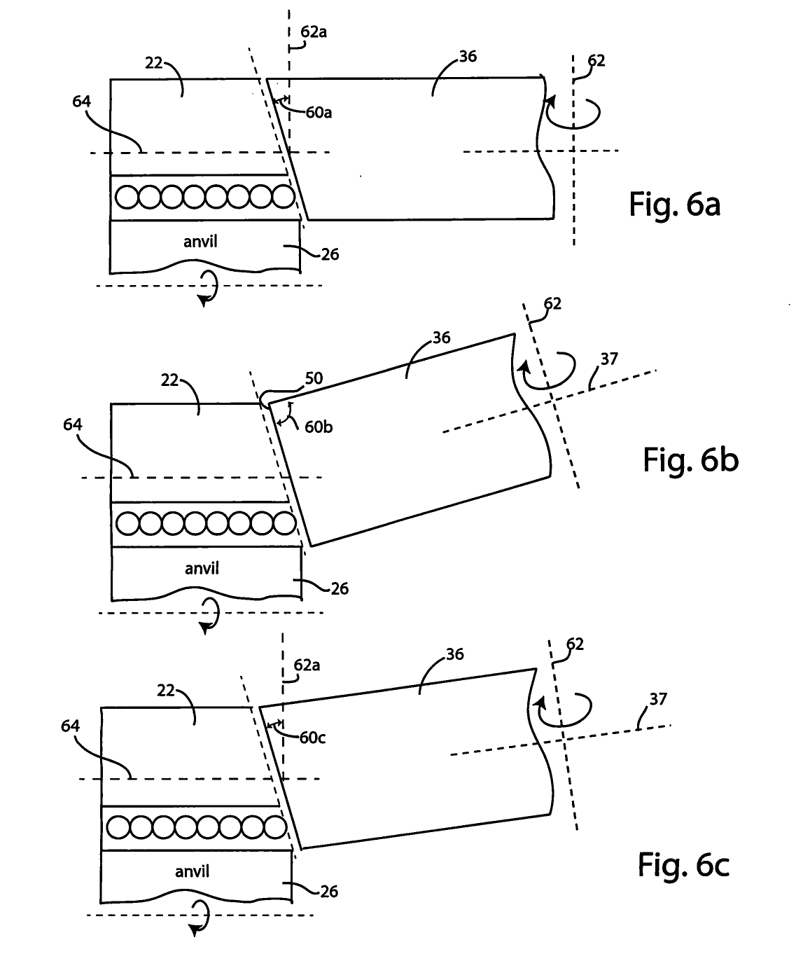

FIGS. 6a, 6b and 6c illustrate different geometry embodiments of the V-belt grinding apparatus and method in accordance with the present disclosure. The geometry embodiment of FIG. 6a corresponds to that of FIG. 1, discussed above. In the FIG. 6a embodiment, the angle or contour formed in belt 22 is established by the corresponding acute angle 60a of the wheel surface 50 relative to a line 62a that is parallel with the wheels axis of rotation 62. In the FIG. 6a embodiment the axis of rotation 62 of grinding wheel 36 is perpendicular to the transverse plane of the belt, illustrated by dashed line 64.

In an alternate embodiment shown in FIG. 6b, the angle or contour of the belt is defined entirely by the angle of the grinding wheel's axis of rotation 62. The grinding wheel 36 has a grinding surface 50 that is perpendicular (angle 60b is 90 degrees) to the plane 37 of the wheel. Thus the surface 50 is parallel to the axis of rotation 62.

In a third embodiment shown in FIG. 6c, the angle or contour of the belt is defined in part by the acute angle 60c of the grinding wheel surface 50 and also in part by the angle of the wheel's rotational axis 62 relative to the transverse plane 64 of the belt.

The embodiment of FIG. 6a is presently preferred from an equipment manufacturing standpoint. This is because the embodiment of FIG. 6a spins the grinding wheels about rotational axes 62 that are perpendicular to the transverse plane 64 of the belt. Thus, in this embodiment, as seen in FIG. 1, the two grinding wheels 36a and 36b are situated with their rotational axes parallel with both axes being perpendicular to the rotational axis of the anvil wheel 26. Because parallel and perpendicular geometries are used in this embodiment, alignment of the grinding wheels and anvil can be effected using straightforward 90° alignment fixtures.

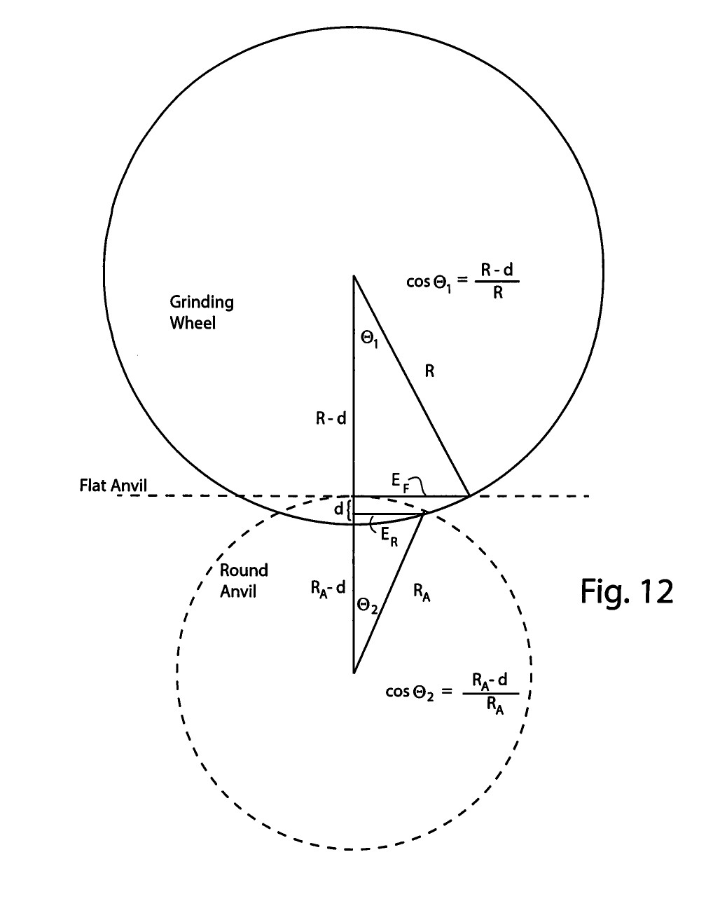

In each of the above embodiments the anvil wheel has a round or circular cross section. The circular nature of the anvil affects the angle of engagement over which the belt workpiece is in position to be ground by the grinding wheel. To see this effect refer to FIG. 12 which compares how a workpiece is engaged by the grinding wheel using a round anvil and alternatively using a flat anvil. In the case where a round anvil is used, the depth of cut into the workpiece (shown as dimension d) corresponds to an engagement distance E_{R} over an angle of θ₂ radians.

By comparison, when a flat anvil is used, the depth of cut into the workpiece (also shown as dimension d) corresponds to an engagement distance E_{F} over an angle of θ₁ radians. As can be seen by this comparison, the angle of engagement for the round anvil is substantially less than the corresponding angle of engagement for a flat anvil, where the same grinding wheel is used in both cases. Use of the round anvil results in a much more concentrated attack of the workpiece, where the grinding wheel's cutting energy is applied to the belt over a much shorter distance (E_{R} is less than E_{F}) even though the depth of grinding d is the same for both cases.

Comparison with Prior Art Technique

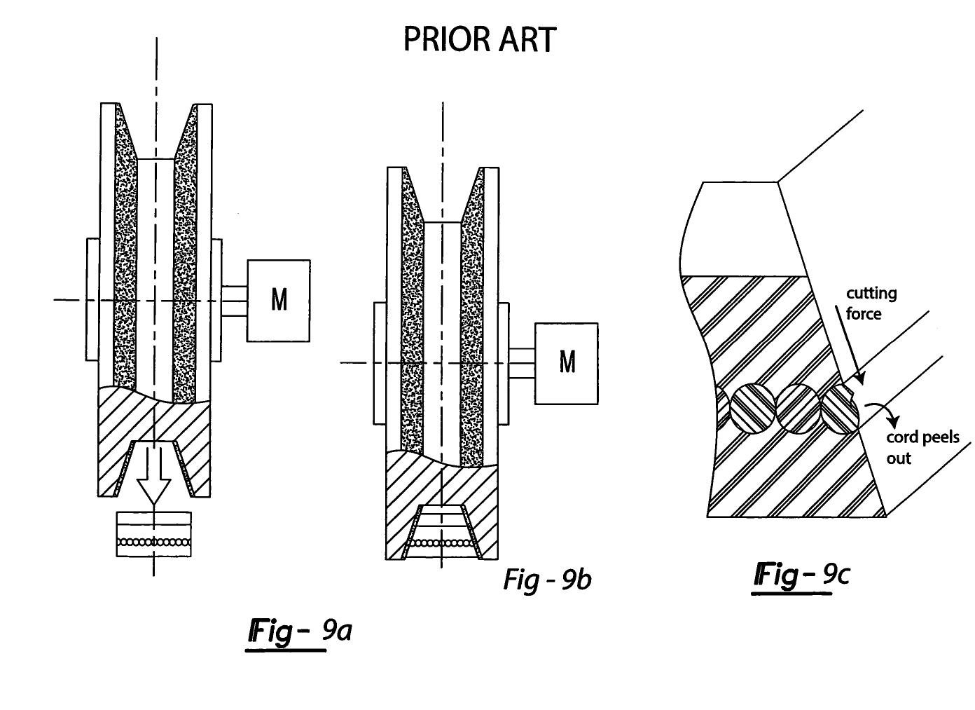

The conventional technique for grinding the belt has been to fabricate a pulley with abrasive side walls and then use that pulley as a tool for grinding. This is shown in FIGS. 9a and 9b. As illustrated, the belt blank is fed into the grinding wheel and material is removed to form the V-shaped profile. While the conventional grinding technique worked reasonably well on belts without reinforcing cords, the technique was fraught with problems when the reinforcing cord was introduced.

Although not understood in the industry, we have discovered that the cutting force of the conventional pulley-shaped grinding tool was actually peeling or pulling the reinforcing cord out from the body of the belt as illustrated in FIG. 9c. Once this peeling occurs the belt must be scrapped. We have analyzed this failure and determined that the geometry of the conventional cutting tool appears to be at fault. The conventional abrasive cutting elements strike the reinforcing cord (across a chord of the circular cross section) with a trajectory generally from outer surface to inner surface of the belt. Due to this geometry, the forces driving the belt radially in toward the axis of rotation of the cutting tool tend to peel the reinforcing cord out from the body of the belt.

By comparison, as seen in FIG. 5c, our cutting or grinding method employs a geometry whereby the cutting points cut in a longitudinal direction along the length of the cord, as one would whittle the bark from a stick. With this beneficial geometry, the cutting forces no longer pull or peel the reinforcing cord from the body of the belt.

### Improved Surface Finish Through Brushing Action

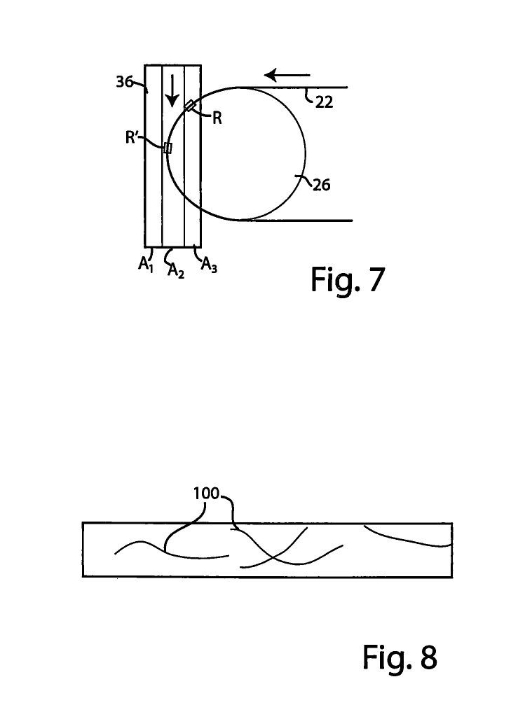

In addition to solving the cord pulling problem, our grinding wheel and anvil geometry provides another significant benefit: an improved finished surface. As shown in FIG. 7, the belt 22 follows a generally U-shaped, circular path in the region where it contacts the anvil 26. Thus, when the belt makes contact with the grinding surface 36, every region of the belt (such as region R) is swept across different circumferential areas A₁, A₂ and A₃ as the belt moves on the rotating anvil. This produces a brushing action whereby individual cutting elements in the different circumferential bands each sequentially contact the region R (as it moves from location R to location R′).

Thus, although the individual cutting elements on the grinding wheel are all traveling in a straight line (from top to bottom in FIG. 7), they contact the belt region R at different trajectory angles due to the circular shape of the anvil. This means that the individual cutting elements attack the belt surface from different angles as the belt moves, following the circular curvature of the anvil. The cumulative effect of being cut from different angles in this fashion produces a highly finished and smooth surface, largely without any parallel, cornrow-like striations caused by individual cutting element . Instead a brushing action is achieved whereby individual striations are erased.

FIG. 8 shows an exemplary trajectory of different cutting points located on different areas of the grinding wheel. Note how the individual paths of individual cutting elements follow different eccentric trajectories. Because these paths tend to differ from one another, a brushing effect occurs where striations caused by one cutting element are erased by other cutting elements following different eccentric trajectories. As diagrammatically illustrated in FIG. 8, note how each cutting element follows a different trajectory, with the cumulative effect being a finely finished surface that exposes the freshly cut natural belt material without undue burnishing or melting that might degrade the uniformity of the surface or damage the natural nap of the rubber or polymeric material.

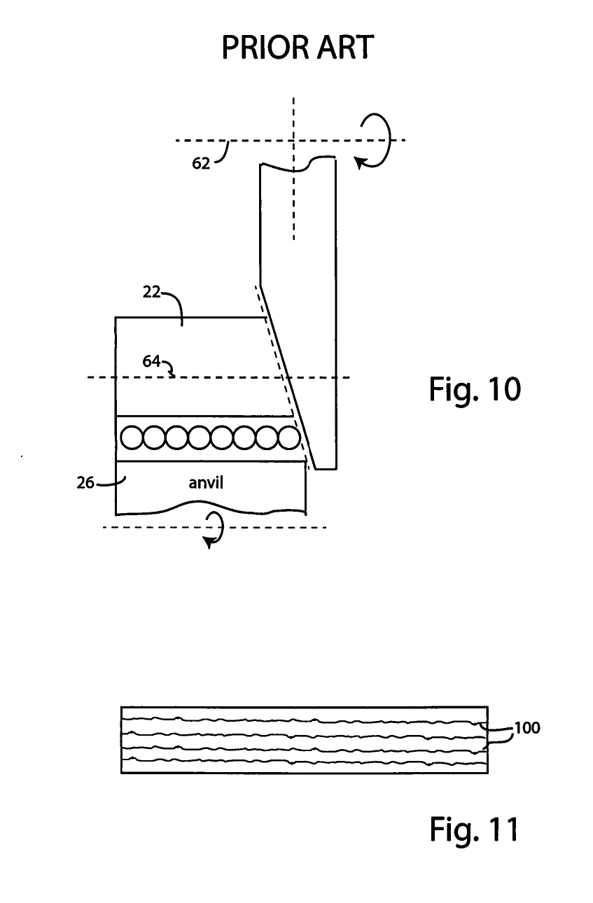

By way of comparison, refer now to FIG. 10, which shows the prior art grinding wheel technique and FIG. 11, which shows the result. In this prior art technique, the rotational axis of the wheel 62 lies parallel to the transverse plane 64 of the belt. The individual cutting teeth make elongated cuts that define generally parallel cornrow-like striations in the sidewalls of the belt, as diagrammatically depicted at 100.

Thus with each of the disclosed embodiments of FIGS. 6a, 6b and 6c, the geometry of the grinding wheel vis-a-vis the anvil wheel, is such that the belt receives a brushing action that produces a smooth surface without ridges or striations from the cutting teeth. The brushing action occurs because the belt actually changes elevation as it passes through the path of the cutting teeth. This is not the case with the prior art configuration shown in FIG. 10. In that configuration, each area of the belt remains at essentially the same elevation with respect to the bottom channel of the grinding pulley, so that individual teeth would strike the same region of the belt during multiple rotations, causing ridges or striations in the belt surface.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An apparatus for producing a V-belt by cutting inwardly tapered sidewalls in a continuous belt workpiece, comprising:
a cutting wheel having a first axis of rotation and having a circumferential cutting surface, the cutting wheel being provided with a first motive system that imparts rotation of the cutting wheel about the first axis;
a moving anvil system adapted to hold the continuous belt workpiece during V-belt production;
the moving anvil system having anvil wheel having a second axis of rotation not parallel to the first axis and having a circumferential workpiece gripping surface, the anvil system being provided with a second motive system that causes the continuous belt workpiece to follow a U-shaped trajectory around the moving anvil and into the path of the cutting wheel;
the anvil wheel being positioned proximate the cutting wheel such that a portion of the continuous belt workpiece makes contact with the circumferential cutting surface and is thereby cut by the cutting wheel;
the circumferential cutting surface and the circumferential gripping surface being mutually disposed such that at the point of contact between workpiece and cutting wheel, the cutting surface and the gripping surface define respective planes that intersect in an acute angle, the acute angle defining an inwardly tapered sidewall of the V-belt being produced.

2. The apparatus of claim 1 further comprising a second cutting wheel spaced apart from said cutting wheel and positioned proximate with said anvil system to make cutting contact with the continuous belt workpiece to define a second inwardly tapered sidewall of the V-belt being produced.

3. The apparatus of claim 2 wherein the second cutting wheel has an axis of rotation that is parallel to the first axis.

4. The apparatus of claim 1 wherein the circumferential cutting surface is tapered to define an acute angle with respect to the first axis of rotation.

5. The apparatus of claim 1 wherein the continuous belt workpiece has embedded reinforcing cord running longitudinally around the continuous belt and wherein the cutting surface and the gripping surface define respective planes that intersect in an acute angle such that the cutting surface cuts generally along the longitudinal dimension of the reinforcing cord as the cutting wheel rotates about the first axis.

6. The apparatus of claim 1 wherein the cutting wheel has plural discrete cutting elements and wherein the circumferential cutting surface and the circumferential gripping surface being mutually disposed such that rotation of the cutting wheel about the first axis and simultaneous rotation of the anvil wheel about the second axis causes the discrete cutting elements to follow different eccentric trajectories across the surface of the tapered sidewall.

7. The apparatus of claim 1 wherein the continuous belt workpiece makes contact with the circumferential cutting surface in an arc of cutting interaction, the arc having a radius of curvature defined by the radius of the anvil wheel.

8. The apparatus of claim 7 wherein the circumferential cutting surface and the circumferential gripping surface are mutually disposed such that over the arc of interaction between workpiece and cutting wheel, the cutting surface and the gripping surface define respective tangential planes that intersect in an acute angle, the acute angle defining an inwardly tapered sidewall of the V-belt being produced.

9. A method of producing a V-belt comprising:
applying motive force to at least one cutting wheel having a first axis of rotation and having a circumferential cutting surface;
placing a continuous belt workpiece on a moving anvil system having an anvil wheel that has a circumferential gripping surface that supports the workpiece for rotation about a second axis of rotation not parallel to the first axis of rotation;
urging the continuous belt workpiece into contact with said cutting wheel and moving the continuous belt workpiece into the path of the cutting wheel by rotating the anvil wheel about the second axis of rotation;
wherein the circumferential cutting surface and the circumferential gripping surface are mutually disposed such that at the point of contact between workpiece and cutting wheel, the cutting surface and the gripping surface define respective planes that intersect in an acute angle, the acute angle defining an inwardly tapered sidewall of the V-belt being produced.

10. The method of claim 9 wherein said at least one cutting wheel comprises a pair of spaced apart cutting wheels that rotate about parallel axes, and the method further comprises rotating said pair of cutting wheels in counter rotating directions.

11. The method of claim 9 wherein the continuous belt workpiece has embedded reinforcing cord running longitudinally around the continuous belt and wherein the method further comprises using the cutting wheel to cut generally along the longitudinal dimension of the reinforcing cord as the cutting wheel rotates about the first axis.

12. The method of claim 9 wherein the cutting wheel has plural discrete cutting elements and wherein the method further comprises driving the continuous belt workpiece in a U-shaped trajectory across the cutting surface so that the discrete cutting elements follow different eccentric trajectories across the surface of the tapered sidewall.

13. The method of claim 9 further comprising driving the continuous belt workpiece into cutting contact with the circumferential cutting surface in an arc of cutting interaction, the arc having a radius of curvature defined by the radius of the anvil wheel.

14. The method of claim 13 wherein the circumferential cutting surface and the circumferential gripping surface are mutually disposed such that over the arc of interaction between workpiece and cutting wheel, the cutting surface and the gripping surface define respective tangential planes that intersect in an acute angle, the acute angle defining an inwardly tapered sidewall of the V-belt being produced.
